(19) United States
(12) Patent Application Publication
(10) Pub. No.: US 2026/0284972 A1
(43) Pub. Date: Sep. 24, 2026

(54) TECHNOLOGY FOR PRODUCING A COMPONENT OF A CONTAINER TREATMENT PLANT

(71) Applicant: KRONES AG, Neutraubling (DE)

(72) Inventors: Martin WAGNER, Regensburg (DE); Andreas NEUBER, Altenstadt an der Waldnaab (DE)

(21) Appl. No.: 19/573,054

(22) Filed: Mar. 20, 2026

(30) Foreign Application Priority Data
Mar. 21, 2025 (DE) 10 2025 111 036.0

(51) Int. Cl. B29C 64/245; B29C 64/118; B33Y 10/00; B33Y 30/00; B33Y 70/10; B33Y 80/00; B29K 105/16

(52) U.S. Cl. CPC B29C 64/245; B29C 64/118; B33Y 10/00; B33Y 30/00; B33Y 70/10; B33Y 80/00; B29K 2105/162

(57) ABSTRACT

The invention relates, inter alia, to a method for producing a component of a container treatment plant. The method comprises additive manufacturing of the component using an additive manufacturing apparatus which has a manufacturing bed with a support face on which the component is additively manufactured. The method further involves forming a structuring into a contact face of the component, which contact face contacts the support face of the manufacturing bed, by means of a predetermined structuring of the support face of the additive manufacturing apparatus during the additive manufacturing of the component.

### CROSS REFERENCE TO RELATED APPLICATIONS

This application claims the benefit under 35 U.S.C. §119(a) of German Patent Application No. DE 10 2025 111 036.0, filed Mar. 21, 2025, entitled TECHNOLOGY FOR PRODUCING A COMPONENT OF A CONTAINER TREATMENT PLANT, and whose entire disclosure is incorporated by reference herein.

### Technical Field

The invention relates to a method for producing a component of a container treatment plant. The invention also relates to an associated component and to an associated container treatment plant.

### Technical Background

The use of additive manufacturing for the on-site supply of customers with replacement parts or wearing parts has the potential of considerably reducing installation downtimes and storage costs. For example, the customer can additively manufacture a corresponding replacement part or wearing part for the installation directly on-site when the part is required. The term "additive manufacturing" is also frequently referred to as 3-D printing or generative manufacturing. However, in the following, only the term "additive manufacturing" will be used.

However, the on-site supply of customers with spare or wearing parts using additive manufacturing also entails certain risks. For example, a customer can select an additive manufacturing apparatus from a pool of multiple available additive manufacturing apparatuses for additive manufacturing. The selected additive manufacturing apparatus may not be suitable for producing the desired component in the desired quality. For example, it may happen that the customer installs an apparently suitable component or replacement part in the machine after additive manufacturing, but the component does not withstand the corresponding influences in the machine. Another aspect concerns issues of anti-counterfeiting protection and product safety, which become relevant for example when a component failure in a machine, possibly with downtime and resulting damage, raises questions as to whether the relevant component was actually manufactured using the approved or authorized additive manufacturing apparatus.

The invention is based upon the object of creating an improved technology for testing and ensuring a desired component quality of an additively manufactured component, preferably of a container treatment plant.

### SUMMARY OF THE INVENTION

The object is achieved by the features of the independent claims. Advantageous developments are specified in the dependent claims and the description.

One aspect relates to a method for producing a component of a container treatment plant (e.g., as disclosed herein). The process involves additive manufacturing of the component using an additive manufacturing apparatus (e.g., a 3-D printer) which has a manufacturing bed (e.g., a print bed) with a support face on which the component is additively manufactured. The method further involves forming a structuring (e.g., structural relief), preferably micro- or sub-microstructuring, into a contact face of the component, which contact face contacts the support face of the manufacturing bed, by means of a predetermined (e.g., manufacturing-bed-specific) structuring (e.g., structural relief), preferably micro- or sub-microstructuring, of the support face of the additive manufacturing apparatus during the additive manufacturing of the component.

Advantageously, the method allows a complementary structuring, caused by the predetermined structuring of the support face, to be formed into the contact face. This structuring can be used, for example, to provide a marking on the component without requiring an additional processing step, such as laser marking, painting, or engraving. The structuring can advantageously be molded directly into the bottom layer of material at the beginning of the additive manufacturing process. The structuring can advantageously be used in many different ways, which can be combined with one another. Advantageously, the structuring can be used in particular as a kind of seal of approval or quality indicator, which can be used for example to document that the correct (suitable) additive manufacturing apparatus was used for the additive manufacturing of the component. The structures of the structuring can identify the component, in an optically unambiguous and easily recognizable manner, as a part from a specific manufacturer or from a specific additive manufacturing apparatus. The structuring can advantageously enable the function of a watermark or fingerprint of the additive manufacturing apparatus. In this context, the structuring can also be used as a factor in multi-factor anti-counterfeiting measures or to increase product safety.

Preferably, the term "contact face" refers to a state in additive manufacturing in which the component rests on the support face of the manufacturing bed via the contact face and is in contact with the support face of the manufacturing bed.

It is possible that the contact face is a functional face of the component for performing a function (e.g., guiding, interlocking, etc.) or that it is not a functional face of the component.

Preferably, the additive manufacturing apparatus can be configured to additively manufacture the component using the FDM method (fused deposition modeling), also called FLM (fused layer modeling) or FFF (fused filament fabrication).

Preferably, the component is formed by a plurality of adjacent, additively manufactured material layers.

In one exemplary embodiment, the structuring of the contact face causes a structural coloration with at least one structural color (e.g., iridescent, shimmering, or hologram-like) of the structuring of the contact face, preferably by at least one of light scattering, light refraction, and light reflection by means of geometric shapes, sizes, and/or arrangements of structures of the structuring of the contact face. Alternatively or additionally, the predetermined structuring of the support face causes a structural coloration with at least one structural color (e.g., iridescent, shimmering, or hologram-like) of the predetermined structuring of the support face, preferably by at least one of light scattering, light refraction, and light reflection by means of geometric shapes, sizes, and/or arrangements of structures of the predetermined structuring of the support face. Advantageously, in this way color effects can be achieved without the need for color pigments (foreign material) or without requiring an additional treatment step for the coloring. Advantageously, this can for example make unauthorized imitation of the structure significantly more difficult. The structural coloration can therefore serve as a security feature, as is used for example in banknotes and official documents to prevent counterfeiting, or at least to make counterfeiting more difficult. Advantageously, the colors of the structural coloration can change depending upon the viewing angle and can be difficult to reproduce.

In another exemplary embodiment, the (e.g., structurally colored) structuring of the contact face and/or of the support face has a marking (e.g., image, label, text, etc.) and/or a wear indicator. Advantageously, any desired information can be provided by means of the marking, e.g., for the individual identification of the additive manufacturing apparatus. It is also possible that the structuring is different for each generation of additive manufacturing apparatuses. This can improve the component quality, for example, if a specific component can only be additively manufactured with a sufficient quality using manufacturing apparatuses of a certain generation. The use as a wear indicator can advantageously indicate a wear condition of the component, a wear condition of the apparatus in which the component is installed, and/or a wear condition of the additive manufacturing apparatus.

In one embodiment, the (e.g., structurally colored) structuring of the contact face and/or the support face has at least one of the following:
at least one alphanumeric character,
preferably a word or a text, a picture; and
a visual code, preferably QR code or bar code (or Aztec code, Data Matrix, PDF417, AR code, alphanumeric code).

The use of codes, images, or text can be advantageous for making it possible to identify the component and/or the additive manufacturing apparatus. Furthermore, it can be advantageous to enable the retrieval of additional information, e.g., by scanning a code that points to the further information.

In another embodiment, the (e.g., structurally colored) structuring of the contact face and/or of the support face includes at least one grid, an (e.g., millimeter) scale, and a coordinate system. Preferably, the method can further include checking the dimensioning of the additively manufactured component by checking the grid, the scale, and/or the coordinate system, preferably manually or by means of an (e.g., camera-based) recording device, e.g., a portable terminal device. Advantageously, grids, scales, and coordinate systems can be used to enable immediate manual or optical dimensional checking, possibly without the need for standard measuring instruments (e.g., calipers or the like). Ideally, the zero point of the coordinate system can be exactly the same as a zero point defined in the virtual 3-D model or G-code. This allows the manufacturing quality and calibration to be checked immediately after the manufacturing process is completed. It can also be advantageous to scan the grid, scale, and/or coordinate system using, for example, a mobile device and to perform a target/actual comparison, e.g., with reference to a construction job ID, to check dimensions, etc., and to document in a database. In addition, the quality of the calibration of the additive manufacturing apparatus can, for example, be dated and documented.

In one embodiment variant, at least one of the following conditions is met:

the (e.g., structurally colored) structuring of the contact face and/or of the support face has an identification character string (e.g., ID or identification number) for identifying the manufacturing bed and/or the additive manufacturing apparatus;

the (e.g., structurally colored) structuring of the contact face and/or of the support face is such that the manufacturing bed and/or the additive manufacturing apparatus can be individually identified by means of the structuring; and

the (e.g., structurally colored) structuring of the contact face and/or of the support face is configured for the individual identification of the additive manufacturing apparatus and/or the manufacturing bed.

Advantageously, the manufacturing of the component can thus be unambiguously traced back to the additive manufacturing apparatus. Different additive manufacturing apparatuses can be uniquely assigned different identifiers (e.g., logo, image, label, serial number, visual code, etc.).

In one exemplary embodiment, at least one of the following conditions is met:

the structuring of the support face and/or of the contact face is dimensioned in such a way that it is not visible to the human eye; and

all the structures of the structuring of the support face and/or contact face are ≤ 30 µm, ≤ 10 µm, or ≤ 5 µm.

The structuring can therefore advantageously be configured in such a way that it is not visible to the naked eye, but can only be seen for example under a microscope. This advantageously provides the option of integrating a cost-effective, invisible-to-the-eye anti-counterfeiting measure.

In another exemplary embodiment, the manufacturing bed has a, preferably exchangeable, bed element, preferably a bed plate or bed foil, with the support face and the predetermined structuring. Preferably, the method can further comprise checking the bed element by means of the additive manufacturing apparatus and, preferably depending thereon, additive manufacturing of the component. For example, the manufacturing apparatus can check the presence of a predetermined marking on the bed element (e.g., camera-based) or check the receipt of a signal from an (e.g., wireless) communications device (e.g., transponder, particularly preferably RFID transponder) of the bed element. Alternatively or additionally, the additive manufacturing of the component can take place dependent upon the receipt or non-receipt of an (e.g., identification) signal from an (e.g., wireless) communications device (e.g., transponder, particularly preferably RFID transponder) of the bed element of the manufacturing bed, wherein preferably, depending upon the receipt or non-receipt of the signal from the communications device, a structured marking is additively manufactured in or on the component, e.g., to indicate information about the receipt or non-receipt of the signal.

Advantageously, a marking can be embedded in the bed element, e.g., in the form of a transponder. The additive manufacturing apparatus can in this way check whether the correct bed element has been attached and, if necessary, can abort the manufacturing, or not start it in the first place. It is also possible that, if an incorrect print element is detected, the component is intentionally additively manufactured differently in certain regions than the 3-D model (i.e., a structured marking is additively manufactured in or on the component). Specifically, for example, the infill of the component could have a different structure than the template, or a “hidden defect” could be manufactured inside the component, e.g., a geometrically clearly defined cavity (e.g., a three-dimensional “F,” for “fake,” or any other error code). If there is doubt as to whether the correct additive manufacturing device was used, the component can then, for example, be cut open and the infill or the hidden error code can be checked.

In one embodiment, the additively manufactured component has at least one nanoparticle marker (marker made of nanoparticles) for identifying a material of the additively manufactured component. Preferably, at least one of the following conditions is also met:

the component is formed entirely from a plurality of adjacent, additively manufactured material layers, and all the material layers have one or more different nanoparticle markers;

the at least one nanoparticle marker has a total volume and/or weight proportion in the component of ≥ 0.5% and/or ≤ 3%;

the at least one nanoparticle marker is a luminescent organic and/or inorganic and/or organometallic dye, a pigment, and/or a complex compound;

the at least one nanoparticle marker was mixed with a base material granulate, preferably plastic granulate, to form a mixture which was extruded into a filament from which the component was additively manufactured; and

a spectrum recorded when the component is irradiated with electromagnetic radiation by a radiation source identifies the material of the component (e.g., by evaluating the recorded spectrum for agreement with at least one predefined spectrum that is assigned to a predetermined material with at least one nanoparticle marker for identifying the predetermined material).

Advantageously, in this way the method can make it possible to detect whether the additively manufactured component was actually additively manufactured from the desired material. For this purpose, nanoparticles are used as markers with which the material can be clearly and reliably identified, e.g., by spectrum analysis. This can advantageously ensure that the correct material was used for the additively manufactured component, which can have a positive effect on component, product, and/or production reliability (e.g., storage, correct component in the machine, etc.). Advantageously, the nanoparticles used as markers do not change the properties of the (base material of the) predetermined material. Advantageously, in combination with the structuring in the contact face, a 2-factor protection can be achieved with which the component quality can be comprehensively documented by identifying the material and by identifying the additive manufacturing apparatus.

It is also possible to perform an electronic comparison between a manufacturing apparatus ID of the additive manufacturing apparatus, a manufacturing bed ID of a bed element of the manufacturing bed, a G-code ID for the component, and a material ID of a material of the component, e.g., to increase product safety or counterfeit protection. If one of these four ID’s is missing or the comparison is incomplete, an error can be output, e.g., to prevent malfunction or misuse.

In a further embodiment, at least one of the following conditions is met:

the component is a wearing part or a replacement part of the container treatment plant; and

the component is a cover component, a starting element, a deflecting element, a sliding element, a spacer element, a finger element, a holder, a sprocket, a chain guide element, a clamp, a clip, a block, a wedge, a bearing element, a driver, a guide element, a ring element, a roller, a wheel, a disk, a bushing, a sleeve, a clamping element, a damping element, a connecting element, or a centering element.

Another aspect relates to a component for a container treatment plant, wherein the component is produced according to a method as disclosed herein. Advantageously, with the component, the same advantages can be achieved as already explained with reference to the method.

A further aspect relates to a container treatment plant. The container treatment plant has at least one container treatment and/or transport apparatus. The container treatment plant further has an additive manufacturing apparatus (e.g., 3-D printer) for the additive manufacturing of a component of the at least one container treatment and/or transport apparatus, preferably according to a method as disclosed herein. The additive manufacturing apparatus has a manufacturing bed (e.g., a print bed) with a support face on which the component can be additively manufactured. The support face has a predetermined (e.g., manufacturing-bed-specific) structuring (e.g., structural relief), preferably micro- or sub-microstructuring, which is configured to form a structuring (e.g., structural relief), preferably micro- or sub-microstructuring, into a contact face of the component, which contact face contacts the support face of the manufacturing bed, during the additive manufacturing of the component. Advantageously, with the container treatment plant, the same advantages can be achieved as already explained with reference to the method. The same applies to the preferred exemplary embodiments of the container treatment plant explained below.

The container treatment plant can for example be configured for controlling the temperature of, producing, cleaning, coating, testing, filling, closing, pasteurizing, decorating, labeling, printing, marking, laser marking, and/or packaging containers for liquid or pasty media, preferably beverages, liquid foodstuffs, or products from the pharmaceutical or healthcare industry. The container treatment plant can, for example, be a beverage filling plant.

For example, the containers can be configured as bottles, cans, canisters, cartons, flasks, vials, tubes, etc.

In one exemplary embodiment, at least one of the following conditions is met:

the predetermined structuring of the support face causes a structural coloration with at least one structural color (e.g., iridescent, shimmering, or hologram-like) of the predetermined structuring of the support face, preferably by at least one of light scattering, light refraction, and light reflection by means of geometric shapes, sizes, and/or arrangements of structures of the predetermined structuring of the support face;

the predetermined (e.g., structurally colored) structuring of the support face includes at least one of: a marking and/or a wear indicator; at least one alphanumeric character, preferably a word or a text; an image; a visual code, preferably a QR code or bar code (or Aztec code, Data Matrix, PDF417, AR code, alphanumeric code); at least one of a grid, an (e.g., millimeter) scale, and a coordinate system; and an identification character string (e.g., ID or identification number) for identifying the manufacturing bed and/or the additive manufacturing apparatus;

the (e.g., structurally colored) predetermined structuring of the support face is configured for the individual identification of the additive manufacturing apparatus and/or the manufacturing bed;

the predetermined structuring of the support face is dimensioned such that it is not visible to the human eye; and

all the structures of the predetermined structuring of the support face are ≤ 30 µm, ≤ 10 µm, or ≤ 5 µm.

In another exemplary embodiment, the manufacturing bed has an exchangeable bed element, preferably a bed plate or bed foil, with which the support face has the (e.g., structurally colored) predetermined structuring.

In one exemplary embodiment, at least one of the following conditions is met:

the bed element has an (e.g., wireless) communications device, preferably a transponder, particularly preferably an RFID transponder, preferably for identifying the bed element to the additive manufacturing apparatus;

the additive manufacturing apparatus has a control device configured to operate the additive manufacturing apparatus depending upon the receipt or non-receipt of an (e.g., identification) signal from a communications device of the bed element, wherein preferably, during the additive manufacturing of the component, a structured marking is additively manufactured in or on the component depending upon the receipt or non-receipt of the (e.g., identification) signal from the communications device, preferably to indicate information about the receipt or non-receipt of the (e.g., identification) signal; and

the manufacturing bed has a receptacle in or on which the bed element is detachably received, and an underside of the bed element and a floor face of the receptacle are shaped to interlock, preferably to snap together.

Advantageously, a special mechanical shape on the underside of the bed element can prevent the bed element with the predetermined structuring from being used on an unsuitable (not released or approved) additive manufacturing apparatus. For example, during an in-house overhaul/update, the additive manufacturing apparatus can be equipped with a new, adapted bed element.

Preferably, the term “control device” can refer to an electronic system (e.g., embodied as a driver circuit or with microprocessors and memory) that can perform control tasks and/or regulating tasks and/or processing tasks depending upon the configuration. Although the term “control” is used herein, this can also comprise or be understood as “closed-loop control” or “control with feedback” and/or “processing,” as appropriate. The control device can, for example, be a central control device or have a plurality of decentralized or distributed control units.

For example, the control device of the additive manufacturing apparatus can be spatially assigned, e.g., arranged in a housing of the additive manufacturing apparatus. Alternatively or additionally, the control device can, for example, be or have a higher-level control unit. This unit can, for example, compare information (e.g., manufacturing apparatus, print bed, material, etc.) and then send a release to the additive manufacturing apparatus.

All features disclosed with reference to the method are also disclosed and claimable with regard to the component disclosed herein and the container treatment plant disclosed herein. All features disclosed with reference to the container treatment plant are also disclosed and claimable with reference to the method disclosed herein and the component disclosed herein.

It will be understood that the method disclosed herein is applicable, disclosed, and claimable for the manufacture of any component (e.g., including a component not intended for a container treatment plant). The same applies to the component disclosed herein.

The preferred embodiments and features of the invention described above can be combined with one another as desired.

### BRIEF DESCRIPTION OF THE FIGURES

Further details and advantages of the invention are described below with reference to the accompanying drawings, in which:

FIG. 1 shows a schematic representation of an additive manufacturing apparatus;

FIG. 2 shows a plan view of a support face of a manufacturing bed of the additive manufacturing apparatus;

FIG. 3 shows a view from below of a contact face of a component; and

FIGS. 4-9 show exemplary structurings.

The embodiments shown in the figures correspond at least in part, so that similar or identical parts are provided with the same reference signs, and reference is also made to the description of other embodiments or figures for the explanation thereof to avoid repetition.

### DETAILED DESCRIPTION OF EXEMPLARY EMBODIMENTS

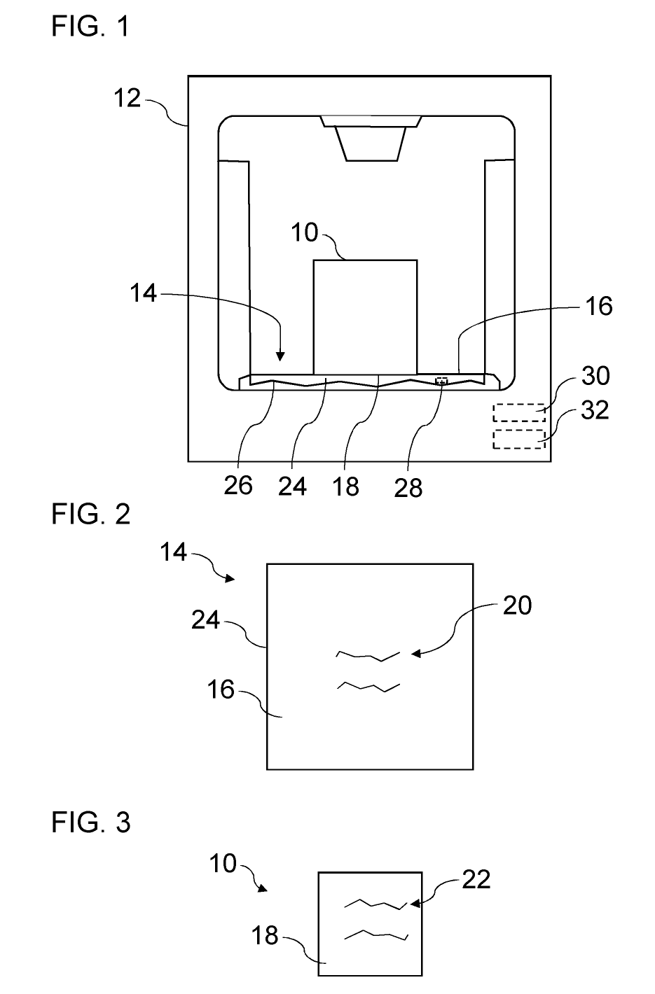

FIG. 1 shows an additively manufactured component 10 and an additive manufacturing apparatus 12.

The component 10 is a component of a container treatment plant. Specifically, the component 10 can be a component of a container treatment and/or container transport apparatus of the container treatment plant.

For example, the container treatment apparatus can have a container-producing apparatus (e.g., container blowing machine), a coating apparatus, a depalletizer, a rinsing apparatus (e.g., with rinsing nozzles), a sterilizing apparatus (e.g., with sterilization nozzles), a filling apparatus (e.g., with filling valves), a closing apparatus (e.g., with closing heads), a labeling apparatus (e.g., with labeling assemblies), a printing apparatus (e.g., with print heads), a pasteurization apparatus, an adhesive-binding-producing apparatus (e.g., with adhesive application nozzles), a packaging apparatus (e.g., with packing heads or film wrappers), and/or a palletizing apparatus (e.g., with palletizing heads, sliding plates, or the like).

The container transport apparatus can be configured to transport containers through the container treatment plant. The container transport apparatus can for example have at least one transport starwheel and/or at least one linear conveyor.

Preferably, the component 10 is a replacement part or wearing part of the container treatment plant, preferably of the container treatment and/or container transport apparatus. For example, the component can be a cover component, a starting element, a deflecting element, a sliding element, a spacer element, a finger element, a holder, a sprocket, a chain guide element, a clamp, a clip, a block, a wedge, a bearing element, a driver, a guide element, a ring element, a roller, a wheel, a disk, a bushing, a sleeve, a clamping element, a damping element, a connecting element, or a centering element.

The component 10 is manufactured using the additive manufacturing apparatus 12, e.g., a 3-D printer. Preferably, the additive manufacturing apparatus 12 is configured to perform additive manufacturing using the FDM/FLM/FFF process, e.g., 3-D printing. Specifically, the control device 32 can be configured to operate the additive manufacturing apparatus 12 for the additive manufacturing of the component 10.

The additive manufacturing apparatus 12 has a manufacturing bed 14 with a support face 16 which has a predetermined structuring 20. The additive manufacturing apparatus 12 can further comprise, for example, a communications interface 30 and/or a control device 32.

The manufacturing bed 14 can also be referred to as a print bed in relation to an additive manufacturing apparatus 12 configured as a 3-D printer.

The component 10 is additively manufactured on the support face 16 and its predetermined structuring 20. Specifically, immediately after the start of additive manufacturing, a contact face 18 of component 10 is in contact with the support face 16. The support face 16 can support the contact face 18 at its base. The contact face 18 can be formed, for example, by a bottom layer of material of the component 10 to be additively manufactured.

The contact face 18 can be oriented in any direction (e.g., upwards, downwards, to the side) when the component 10 is installed in the corresponding container treatment and/or container transport apparatus.

As already mentioned, the support face 16 has the predetermined structuring 20, as shown by way of example in FIG. 2. The predetermined structuring 20 can, for example, extend only over a portion of the support face 16 or over the entire support face 16. Preferably, the predetermined structuring 20 extends at least over a central portion or a centrally arranged portion of the support face 16.

The predetermined structuring 20 can be laser-etched or pressed into the support face 16, e.g., embossed, or cut into it, e.g., engraved.

The predetermined structuring 20 of the support face 16 results in a structuring 22 of the contact face 18 of the component 10 during additive manufacturing, as shown by way of example in FIG. 3. The structuring 22 can, for example, extend only over a portion of the contact face 18 or over the entire contact face 18. Preferably, the structuring 22 extends at least over a central portion or a centrally arranged portion of the contact face 18.

Specifically, during the additive manufacturing of the component 10, the structuring 22 is formed (see FIG. 3) into the contact face 18 of component 10 using the predetermined structuring 20 of the support face 16 of the manufacturing bed 14 (see FIG. 2). The predetermined structuring 20 of the manufacturing bed 14 can be transferred as structuring 22 of the contact face 18. The structuring 22 in the contact face 18 of the component 10 is formed by means of the predetermined structuring 20 of the support face 16 - for example, complementary to it.

For example, material can be applied from a nozzle unit of the additive manufacturing apparatus 12 into the predetermined structuring 20. The material can, for example, be heated and/or deformable (e.g., viscous) and fit into - e.g., flow into - the predetermined structuring 20. The structuring 22 of the contact face 18 can thus mold the predetermined structuring 20 of the support face 16. Preferably, the predetermined structuring 20 and the structuring 22 can form negative and positive shapes that fit together.

The structuring 20, 22 is preferably a microstructuring or a sub-microstructuring, e.g., nanostructuring. Structures of the structuring 20, 22 can be dimensioned in the micrometer or submicrometer range (e.g., nanometer range).

The structuring 20, 22 particularly preferably causes a structural coloration of the structuring 20, 22. The structural coloration can be iridescent, shimmering, or hologram-like. The structural coloration can be caused by light scattering, light refraction, and/or light reflection by means of geometric shapes, sizes, and/or arrangements of structures of the structuring 20, 22. Such a structuring 20, 22 can be designated, for example, a color-effect-producing microstructure.

Structural coloration is a phenomenon in which colors are produced by the structure of a surface (here, structuring 20, 22 of a surface of the support face 16 or the contact face 18) and not by pigments. These colors arise from the interaction of light with microscopic structures of the structuring 20, 22, which reflect, refract, and/or scatter light in certain wavelengths.

A well-known example of structural coloration in nature is the butterfly wing. The iridescent colors can be created by tiny, regularly arranged scales that affect the light in various ways. The iridescent colors of soap bubbles and the metallic colors of beetles are also due to structural coloration.

In structural coloration, all three phenomena – light scattering, light refraction, and light reflection – can play a role. Light scattering can cause light to be distributed in different directions when it encounters microscopic structures of the structuring 20, 22. This can lead to iridescent colors, such as those seen in butterfly wings. Refraction of light occurs when light passes through materials with different refractive indices. This can lead to color changes, depending upon how the light is refracted through the structuring 20, 22. An example of this are the colors that can arise from the structure of gemstones. Light reflection is the back-radiation of light from a surface. In structural coloration, the reflection can be enhanced by regular patterns of the structuring 20, 22, which can lead to intense and vibrant colors. This is seen for example in metallic beetles or certain fish species.

Preferably the structuring 20, 22, or at least the structural coloration caused by it, if present, is visible to the human eye. However, it is also possible that all the structures of the structuring 20, 22 are not visible to the human eye and do not cause any structural coloration. For example, all the structures of the structuring 20, 22 can be ≤ 30 µm, ≤ 10 µm, or ≤ 5 µm, e.g., with respect to their height.

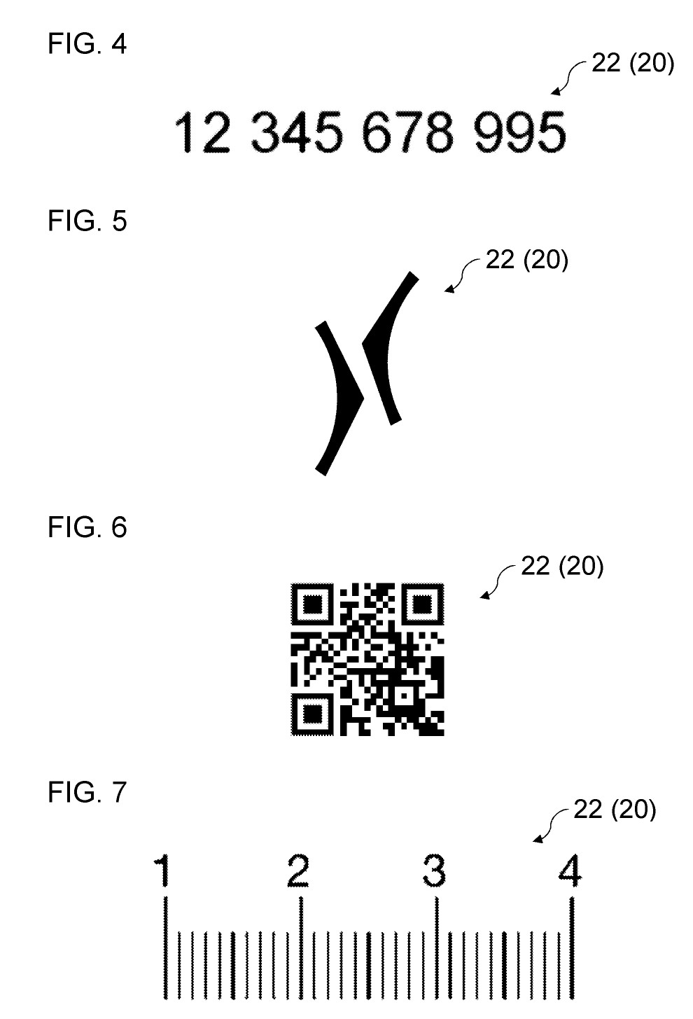

FIGS. 4-9 show examples of structuring 22 in the contact face 18 which are visible, for example, to the human eye or only under a microscope. The associated predetermined structuring 20 in each case can, for example, be configured as a negative shape of the structuring 22 or complementary to the structuring 22.

FIG. 4 shows that the structuring 22 can for example contain alphanumeric characters, e.g., a sequence of numbers, a word, or a text. Preferably, the structuring 22 can include an identification character sequence, e.g., ID or identification number, for identifying the manufacturing bed 14 and/or the additive manufacturing apparatus 12. The identification character string can be specific to each manufacturing apparatus. The manufacturing bed 14 and/or the additive manufacturing apparatus 12 can be individually identified by means of the identification character sequence.

In general terms, the structuring 22 of the contact face 18 (and consequently also the predetermined structuring 20 of the support face 16) can be configured for the individual identification of the additive manufacturing apparatus 12 and/or the manufacturing bed 14. In this context, it is not necessary for the structuring 20, 22 to have, for example, an identification character string. Individual identification can also be enabled in other ways by means of the structuring 20, 22, e.g., with a structuring 20, 22 which has a manufacturing-apparatus-specific or manufacturing-bed-specific image or a manufacturing-apparatus-specific or manufacturing-bed-specific visual code.

FIG. 5 shows that the structuring 22 can, for example, have an image. The image can, for example, be a pictogram, logo (e.g., a manufacturer's logo or customer logo), or the like.

FIG. 6 shows that the structuring 22 can have a visual code. The visual code can, for example, be a QR code, as shown. Alternatively, the visual code can, for example, be a bar code, Aztec code, Data Matrix, PDF417, AR code, or alphanumeric code.

FIG. 7 shows that the structuring 22 can have a scale. For example, the scale can be a centimeter scale or a millimeter scale.

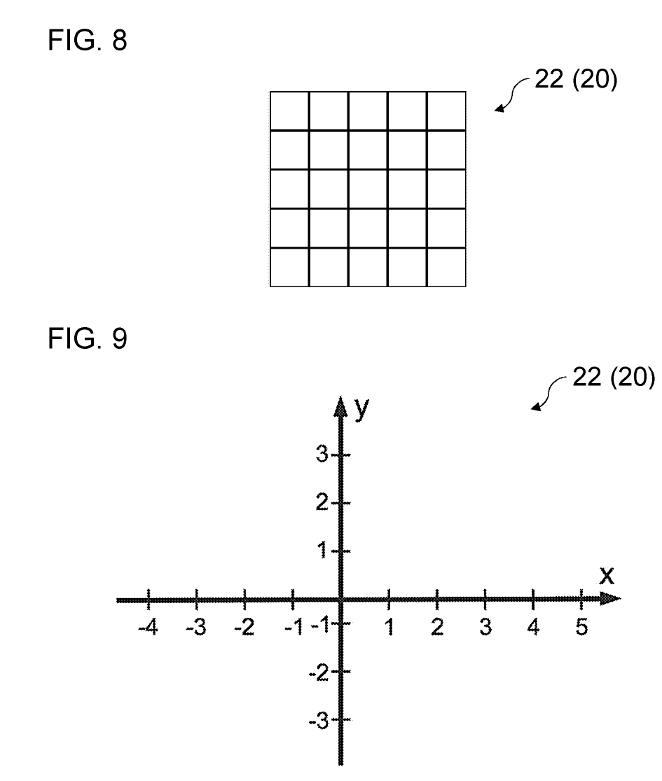

FIG. 8 shows that the structuring 22 can have a grid. For example, the grid can be a centimeter grid or a millimeter grid.

FIG. 9 shows that the structuring 22 can have a coordinate system. The coordinate system can, for example, be a linear coordinate system. Preferably, the zero point of the coordinate system can be exactly the same as a zero point defined in the virtual 3-D model of the component or in the G-code of component 10.

Using the scale (e.g., FIG. 7), the grid (e.g., FIG. 8), and/or the coordinate system (e.g., FIG. 9), the dimensioning of component 10, for example, can be checked by checking the scale/grid/coordinate system in the contact face 18. The checking can be done manually or using a recording device, e.g., a portable device (e.g., tablet computer or smartphone).

FIGS. 4-9 show examples in which the structuring 22 (20) has an identifier (e.g., character string, image, visual code, etc.). Alternatively or additionally, it is possible, for example, that the structuring 22 (20) has a wear indicator. For example, increasing clogging of the predetermined structuring 20 after a large number of additive manufacturing processes can lead to the structuring 22 being less pronounced. This can be seen as an indicator that, for example, the additive manufacturing apparatus 12 needs maintenance and/or that the bed element 24 needs to be replaced. As another example, a wear indicator on the contact face 18 can, for instance with increasing abrasion of the contact face 18 during the use of the component 10, be an indicator that the component 10 needs to be replaced or that the associated container treatment and/or transport apparatus needs maintenance, e.g., because the abrasion occurs too quickly, is too strong, or should not occur at all.

With further reference to FIG. 1, it is shown by way of example that the manufacturing bed 14 can preferably have a replaceable / exchangeable bed element 24. The bed element 24 can be configured, for example, as a preferably rigid bed plate or as a preferably flexible or bendable bed foil.

The bed element 24 can also be referred to as a print bed element in relation to an additive manufacturing apparatus 12 configured as a 3-D printer.

The bed element 24 can have the support face 16 with the predetermined structuring 20. Preferably, the support face 16 with the predetermined structuring 20 can be arranged on a top side of the bed element 24 or can form the top side of the bed element 24.

The bed element 24 can be detachably mounted in or on a receptacle 26 of the manufacturing bed 14. Preferably, an underside of the bed element 24 and a floor face of the receptacle 26 can interlock. The underside of the bed element 24 and the floor face of the receptacle 26 preferably have a shape that deviates from a flat face. For example, at least one locking element can be arranged on an underside of the bed element 24 and on a floor face of the receptacle 26, which can lock together.

Preferably, an underside of the bed element 24 and a floor face of the receptacle 26 can have complementarily shaped structures. Preferably, the bed element 24 and the receptacle 26 can be connected to each other via a connection mechanism with a key-lock principle.

It is possible for the bed element 24 to have a communications device 28. The communications device 28 is preferably a wireless communications device. For example, the communications device 28 can be a transponder, such as an RFID transponder. Alternatively, it is possible that the communications device 28 is, for example, wired and has a physical connection contact for contacting.

The communications device 28 can be used to identify the bed element 24 - for example, in relation to the additive manufacturing apparatus 12. For example, an identification character string, such as an ID or identification number, of the bed element 24 can be sent by the communications device 28.

For example, the communications device 28 of the bed element 24 can communicate with a communications interface 30 of the additive manufacturing apparatus 12. The communications can be wireless or wired. The communications interface 30 can for example receive the identification character string of the bed element 24 from the communications device 28. Preferably, the communications interface 30 can forward a signal received from the communications device 28 to the control device 32.

The control device 32 can be configured to operate the additive manufacturing apparatus 12 depending upon receipt or non-receipt of a signal from the communications device 28. Preferably, during the additive manufacturing of the component 10, a structured marking can be additively manufactured in or on component 10 depending upon receipt or non-receipt of the signal from the communications device 28. This marking can provide information about whether the signal was received or not. The marking can be provided, for example, if the signal has been received. Alternatively, the marking can be provided, for example, if the signal was not received.

The additive manufacturing apparatus 12 can additionally or alternatively check the bed element 24 in some other way. For example, the additive manufacturing apparatus 12 can check for the presence of a marking, e.g., an optical one, on the bed element 24 -for example, using a camera. The control device 32 can be configured to operate the additive manufacturing apparatus 12 depending upon the presence or absence of the marking of the bed element 24.

It is possible that the additively manufactured component 10 has at least one nanoparticle marker for identifying a material of the component 10. Preferably, the nanoparticle marker can be embedded in the material or can become part of the component 10 during the additive manufacturing.

By means of the at least one nanoparticle marker, it can be possible to identify a material of the component 10. For example, a material of the component 10 can be identified as described in German patent application 102023132 636.8. German patent application 10 2023 132 636.8 is incorporated herein by reference, in particular with regard to the method disclosed therein for identifying a material of a component, with regard to the mobile device disclosed therein, with regard to the method disclosed therein for producing a component for a container treatment plant, and with regard to the component disclosed therein. All of these aspects mentioned can be combined with all the features disclosed herein, individually or in any combination.

For example, the component 10 can be formed entirely from a plurality of adjacent, additively manufactured material layers, and all the material layers can have at least one nanoparticle marker. The at least one nanoparticle marker can for example have a total volume and/or weight proportion in the component 10 of ≥ 0.5% and/or ≤ 3%. The at least one nanoparticle marker can for example be a luminescent organic and/or inorganic and/or organometallic dye, a pigment, and/or a complex compound. The at least one nanoparticle marker can for example be mixed with a base material granulate, preferably plastic granulate, to form a mixture that was extruded into a filament from which the component 10 was additively manufactured. A spectrum recorded during irradiation with electromagnetic radiation by means of a radiation source of component 10 can identify the material of component 10.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the subclaims are also disclosed and claimable independently of all the features of independent claim 1. All ranges specified herein are to be understood as disclosed and claimable in such a way that all values falling within the relevant range are individually disclosed, e.g., also as the relevant preferred, narrower outer limits of the relevant range.

### LIST OF REFERENCE SIGNS

10 component

12 additive manufacturing apparatus

14 manufacturing bed

16 support face

18 contact face

20 structuring

22 structuring

24 bed element

26 receptacle

28 communications device

30 communications interface

32 control device

What is claimed is:

1. A method for producing a component for a container treatment plant, wherein the method comprises:
additive manufacturing of the component by means of an additive manufacturing apparatus which has a manufacturing bed with a support face on which the component is additively manufactured; and
forming a structuring into a contact face of the component, which contact face contacts the support face of the manufacturing bed, by means of a predetermined structuring of the support face of the additive manufacturing apparatus during the additive manufacturing of the component.

2. The method according to claim 1, wherein at least one of:
the structuring formed into the contact face of the component is a micro- or sub-microstructuring;
the predetermined structuring is a micro- or sub-microstructuring;
the structuring of the contact face causes a structural coloration of the structuring of the contact face; and
the predetermined structuring of the support face causes a structural coloration of the predetermined structuring of the support face.

3. The method of claim 2, wherein at least one of:
the structuring of the contact face causes the structural coloration of the structuring of the contact face by at least one of light scattering, light refraction, and light reflection by means of at least one of geometric shapes, sizes, and arrangements of structures of the structuring of the contact face; and
the predetermined structuring of the support face causes the structural coloration of the predetermined structuring of the support face by at least one of light scattering, light refraction, and light reflection by means of at least one of geometric shapes, sizes, and arrangements of structures of the predetermined structuring of the support face.

4. The method according to claim 1, wherein:
the structuring of at least one of the contact face and the support face has at least one of a marking and a wear indicator.

5. The method according to claim 1, wherein the structuring of at least one of the contact face and the support face has at least one of:
at least one alphanumeric character, a word or a text,
a picture; and
a visual code, a QR code or bar code.

6. The method according to claim 1, wherein:
the structuring of at least one of the contact face and the support face includes at least one of a grid, a scale, and a coordinate system.

7. The method according to claim 6, wherein the method further comprises:
verification of the dimensioning of the additively manufactured component by checking at least one of the grid, the scale, and the coordinate system.

8. The method according to claim 1, wherein at least one of the following conditions is met:
the structuring of at least one of the contact face and the support face includes an identification character string for identifying at least one of the manufacturing bed and the additive manufacturing apparatus;
the structuring of at least one of the contact face and the support face is such that at least one of the manufacturing bed and the additive manufacturing apparatus can be individually identified by means of the structuring; and
the structuring of at least one of the contact face and the support face is configured for individual identification of at least one of the additive manufacturing apparatus and the manufacturing bed.

9. The method according to claim 1, wherein at least one of the following conditions is met:
the structuring of at least one of the support face and the contact face is dimensioned in such a way that it is not visible to the human eye; and
all structures of the structuring of at least one of the support face and the contact face are ≤ 30 µm, ≤ 10 µm, or ≤ 5 µm.

10. The method according to claim 1, wherein:
the manufacturing bed has a bed element with the support face and the predetermined structuring.

11. The method according to claim 10, wherein at least one of the following conditions is met:
the bed element is exchangeable;
the bed element is a bed plate or bed foil;
checking the bed element by means of the additive manufacturing apparatus;
the additive manufacturing of the component takes place dependent upon the receipt or non-receipt of a signal from a communications device of the bed element of the manufacturing bed; and
the additive manufacturing of the component takes place dependent upon the receipt or non-receipt of a signal from a communications device of the bed element of the manufacturing bed, wherein, depending upon the receipt or non-receipt of the signal from the communications device, a structured marking is additively manufactured in or on the component, to indicate information about the receipt or non-receipt of the signal.

12. The method according to claim 1, wherein:
the additively manufactured component has at least one nanoparticle marker for identifying a material of the additively manufactured component.

13. The method according to claim 12, wherein at least one of the following conditions is met:
the component is formed entirely from a plurality of adjacent, additively manufactured material layers, and all the material layers have one or more different nanoparticle markers;
the at least one nanoparticle marker has at least one of a total volume and weight proportion in the component of at least one of ≥ 0.5% and ≤ 3%;
the at least one nanoparticle marker is at least one of a luminescent organic dye a luminescent inorganic dye, a luminescent organometallic dye, a pigment, and a complex compound;
the at least one nanoparticle marker was mixed with a base material granulate, or a plastic granulate, to form a mixture which was extruded into a filament from which the component was additively manufactured; and
a spectrum recorded during irradiation of the component with electromagnetic radiation by means of a radiation source identifies the material of the component.

14. The method according to claim 1, wherein at least one of the following conditions is met:
the component is a wearing part or a replacement part of the container treatment plant; and
the component is a cover component, a starting element, a deflecting element, a sliding element, a spacer element, a finger element, a holder, a sprocket, a chain guide element, a clamp, a clip, a block, a wedge, a bearing element, a driver, a guide element, a ring element, a roller, a wheel, a disk, a bushing, a sleeve, a clamping element, a damping element, a connecting element, or a centering element.

15. A component for a container treatment plant, wherein the component is manufactured according to a method according to claim 1.

16. A container treatment plant, comprising:
at least one container treatment and/or transport apparatus; and
an additive manufacturing apparatus for additively manufacturing a component of the at least one container treatment and/or transport apparatus,
wherein:
the additive manufacturing apparatus has a manufacturing bed with a support face on which the component can be additively manufactured, wherein the support face has a predetermined structuring, wherein the predetermined structuring is configured to form a structuring into a contact face of the component, which contact face contacts the support face of the manufacturing bed, during the additive manufacturing of the component.

17. The container treatment plant according to claim 16, wherein at least one of the following conditions is met:
the predetermined structuring of the support face causes a structural coloration of the predetermined structuring of the support face;
the predetermined structuring of the support face has at least one of:
at least one of a marking and a wear indicator;
at least one alphanumeric character, a word or a text;
a picture;
a visual code, a QR code or bar code;
at least one of a grid, a scale, and a coordinate system; and
an identification character string for identifying at least one of the manufacturing bed and the additive manufacturing apparatus;
the predetermined structuring of the support face is configured for the individual identification of at least one of the additive manufacturing apparatus and the manufacturing bed;
the predetermined structuring of the support face is dimensioned such that it is not visible to the human eye; and
all structures of the predetermined structuring of the support face are ≤ 30 µm, ≤ 10 µm, or ≤ 5 µm.

18. The container treatment plant according to claim 16, wherein:
the manufacturing bed has an exchangeable bed element with the support face having the predetermined structuring.

19. The container treatment plant according to claim 18, wherein at least one of the following conditions is met:
the bed element has a communications device;
the additive manufacturing apparatus has a control device that is configured to operate the additive manufacturing apparatus depending upon a receipt or non-receipt of a signal from a communications device of the bed element; and
the manufacturing bed has a receptacle in or on which the bed element is detachably received, and an underside of the bed element and a floor face of the receptacle are shaped to interlock or snap together.

20. The container treatment plant according to claim 19, wherein at least one of the following conditions is met:
the communications device is a transponder or an RFID transponder;
the communications device is for identifying the bed element to the additive manufacturing apparatus; and
the control device is configured to operate the additive manufacturing apparatus depending upon the receipt or non-receipt of the signal from a communications device of the bed element, wherein, during the additive manufacturing of the component, a structured marking is additively manufactured in or on the component depending upon the receipt or non-receipt of the signal from the communications device, to indicate information about the receipt or non-receipt of the signal.
